(19) United States
(12) Patent Application Publication
(10) Pub. No.: US 2005/0252071 A1
(43) Pub. Date: Nov. 17, 2005

(54) Multiple fishing rod holding bucket

(76) Inventor: Steven D. Urban, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/120,815

(22) Filed: May 3, 2005

Related U.S. Application Data
(60) Provisional application No. 60/570,192, filed on May 12, 2004.

(51) Int. Cl. A01K 97/10; A01K 97/06

(52) U.S. Cl. 43/21.2; 43/54.1

(57) ABSTRACT

A fishing rod holder bucket having a pair of rod holders affixed to the upstanding wall of the bucket. One rod holder is oriented in a first slanted direction and the second rod holder is oriented in a second slanted direction opposite to the first direction, whereby the bucket is positioned during use such that one rod holder and its retained fishing rod slant to the left side while the other rod holder and its retained fishing rod slant to the right side, such that the distance between the fishing rod tips is maximized in order to decrease the likelihood of rod tip interference and line entanglement.

This application claims the benefit of U.S. Provisional Patent Application Ser. No. 60/570,192, filed May 12, 2004, the disclosure of which is incorporated herein by reference.

### BACKGROUND OF THE INVENTION

This invention relates generally to the field of portable devices for holding or retaining fishing rods during the act of fishing, and more particularly relates to such devices associated with or incorporated in a bucket or pail, such that the bucket or pail can be utilized for transport and storage of fishing equipment and accessories.

Fishing with a rod and reel typically involves casting a bait or lure into the water and either working the bait or lure by movement of the rod or reeling in the line, or simply allowing the bait or lure to remain relatively stationary until a fish strikes. In the latter circumstance, long periods of time may pass between the casting and the strike, or retrieval of the bait or lure. During this time, if no alternatives are at hand, the fisherman holds the rod continually, leans the rod against a railing or other support, or sets the rod directly on the ground. If the fisherman uses more than one rod at the same time, holding the rods is not an option. Rods that are leaned or placed on the ground are susceptible to accidental damage from being stepped on, having heavy objects placed onto them, etc.

Various devices have been created to independently hold or support a fishing rod in order to alleviate the need for the fisherman to continually grasp the rod. A simple form of rod holder consists of a short tube sized to receive the butt or handle of the fishing rod. The tube may be mounted on or formed as part of a larger fixed structure, such as in the gunwales of a boat or on the rails of a fishing pier, or may be provided with an anchor or staking structure allowing it to be driven into the shore or beach in an upright or slanted orientation. Formed wire constructions for holding the butt of the rod are also known.

Another variant embodiment for a fishing rod holder is to associate or attach the holder to a portable object, such as a chair, tackle box, bucket or the like. In particular, attaching the rod holder to a bucket or incorporating a rod holding structure within a bucket provide reasonable solutions to the rod holding problem, since the functionality of the bucket is particularly useful in a fishing scenario. A bucket provides a readily portable container to transport and store other fishing equipment, accessories and supplies, can be used to retain solids, liquids, bait or the caught fish themselves, and is easily cleaned and stored.

In some instances, the rod holder or holders comprises a tubular or wire frame structure adapted to receive the rod butt, with the holder being mounted to the exterior of the bucket, either permanently or removably, in a stationary or adjustable orientation. Examples of such devices are shown in U.S. Pat. No. 5,131,179 to McEwen, U.S. Pat. No. 5,319,877 to Hagan, U.S. Pat. No. 5,491,923 to Zingrone, U.S. Pat. No. 5,634,291 to Pham, U.S. Pat. No. 6,658,786 to Williams, U.S. Pat. No. D384,391 to Bastian, and U.S. Pat. No. D288,953 to Hansen. In other instances, annular structures with vertical tubes or slots are disposed in the interior of the bucket, such as shown for example in U.S. Pat. No. 6,254,055 to Lamberson, Jr., U.S. Pat. No. 6,364,150 to Persinger, and U.S. Pat. No. D328,775 to Galante.

These devices are deficient in various aspects. Rods holders temporarily mounted to a bucket are less stable and less secure, and may be lost when detached from the bucket. Rod holders mounted on the exterior of the bucket are impediments to compact storage of the bucket when not in use, occupy a larger footprint when in use, which is detrimental when the device is used on a small boat or pier with limited surface area, are likely to snag on other objects during use or storage, and increase the likelihood of the bucket being kicked or knocked over. The known structures for holding fishing rods that are mounted or disposed on the interior of the bucket do not allow the rods to be angled out of vertical.

Another problem encountered with the known designs for rod holders is that where means are provided to hold two or more rods, the rod holders are not oriented to maximize separation of the rod tips. Current designs typically have pairs of rod holders slanted in the same direction. Thus the rod tips for similar length rods are separated only a distance equal to the width of the bucket. When the rod tips are in such close proximity to each other, the likelihood of interference between rods and line entanglement is greatly increased, especially when a fish strike occurs such that the rod tip and line is pulled and moved, and quick removal of the rod from the holder is necessary in order to capture the fish.

It is an object of this invention to provide a fishing rod holder capable of holding two or more rods in a manner that obviates the problems mentioned above. In particular, it is an object to provide a fishing rod holder device comprising a bucket or similar container wherein the rods are maintained so as to point in opposite directions, such that the distance between the rod tips is maximized.

### SUMMARY OF THE INVENTION

The invention is a fishing rod holder bucket or similar container device, i.e., a bucket or similar container having means to retain and hold at least a pair of fishing rods, wherein the rod holding means are a pair of tubes affixed to the wall of the bucket, preferably on the interior, either in a stationary or variable orientation. One rod holder is oriented in a first slanted direction and the second rod holder is oriented in a second slanted direction opposite to the first direction, whereby the bucket is positioned during use such that one rod holder and its retained fishing rod slant to the left side while the other rod holder and its retained fishing rod slant to the right side relative to the direction in which the fishing lines extend, such that the distance between the fishing rod tips is maximized in order to decrease the likelihood of rod tip interference and line entanglement.

### BRIEF DESCRIPTION OF THE DRAWINGS

FIG. 1 is a front view of the invention, showing a pair of rod holders oriented in opposite directions.

FIG. 2 is a combined cross-sectional and partially exposed view taken along line II-II of FIG. 1, showing a rod holder mounted on the interior of the bucket.

FIG. 3 is a top view of the invention.

FIG. 4 is a partial view of an alternative embodiment of the invention, wherein a slot is provided in the wall of the bucket to allow the relative angle of the rod holder to be adjusted.

FIG. 5 is a view of the invention shown retaining a pair of fishing rods, the rod tips being separated by a maximum distance.

FIG. 6 is a front view of an alternative embodiment of the invention.

### DETAILED DESCRIPTION OF THE INVENTION

With reference to the illustrations, the invention will now be described in detail with regard for the best mode and the preferred embodiment. In general the invention is a fishing rod holder bucket or similar container, i.e., a bucket having means to retain and hold at least a pair of fishing rods, wherein the rod holding means are a pair of tubes affixed to the wall of the bucket. One rod holder is oriented in a first slanted direction and the second rod holder is oriented in a second slanted direction, non-parallel and most preferably diametrically opposite to the first direction, i.e., at approximately 180 degrees, such that the distance between the fishing rod tips is maximized in order to decrease the likelihood of rod tip interference and line entanglement. The bucket is positioned during use such that one rod holder and its retained fishing rod slant to the left side while the other rod holder and its retained fishing rod slant to the right side.

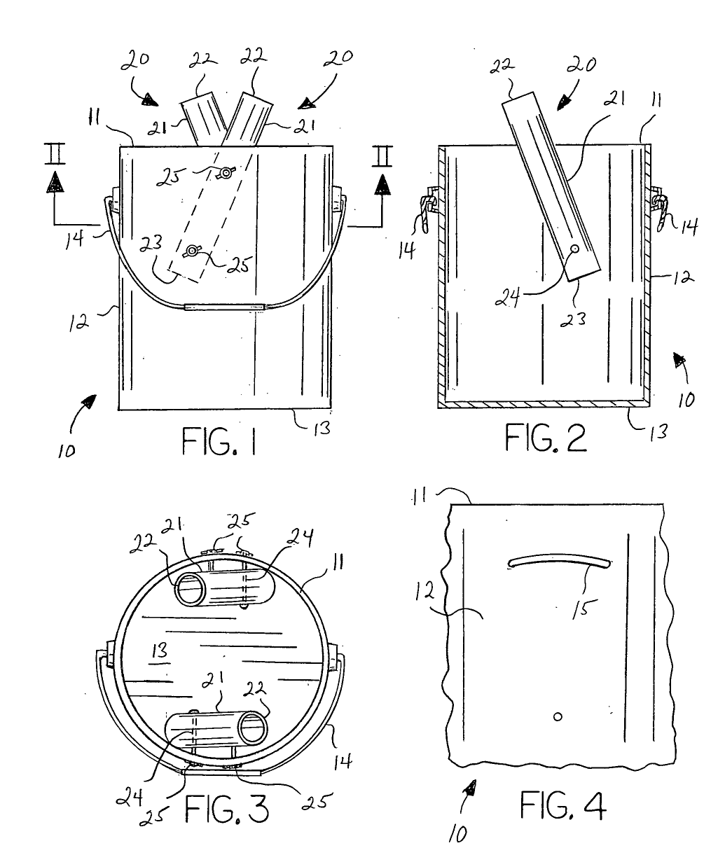

The invention comprises a bucket or similar walled container 10 and multiple rod holders 20, most preferably a pair of rod holders 20 as shown in FIGS. 1 and 3. The bucket 10 may be of any standard configuration and of various sizes, and is not restricted to being circular in cross-section, in that any open topped container of similar construction and design may be utilized, such as for example a rectangular crate. The bucket 10 comprises a rim 11 defining an open top, an annular upstanding wall 12, a flat bottom 13, and a handle 14, which may be composed of metal as in FIGS. 1 through 3, rope as in FIG. 6, or similar suitable materials. The bucket 10 is preferably composed of a durable plastic, and may be colored, camouflaged, etc. Such bucket designs are well known.

The rod holders 20 as shown in FIGS. 1 through 3 each comprise a sleeve body 21, an open top 22 to allow passage therethrough of the butt of a fishing rod 98, an open bottom 23 to allow water drainage, and a rod stop member 24. The rod holders 20 may be composed of wire frame members or metal tubes, but it is preferred that the sleeve body 21 be manufactured of a durable, rigid plastic, such as for example PVC tubing. The diameter and length of the sleeve body 21 may vary, provided it is of sufficient diameter and length to allow for relatively easy insertion and removal of typical fishing rod 98 butts or handles, while not being so large as to allow for excessive lateral movement. A sleeve body 21 composed of thin-walled PVC tubing having an outer diameter of approximately 1.75 inches and a length of approximately 8.5 inches has been found to be suitable for both fresh and saltwater fishing rods 98. A finished sleeve member 27, created for example by using a standard PVC coupling member, may be positioned on the open top 22 of the sleeve body 21 to create a smoother upper edge as shown in FIG. 6. The uppermost portion of the rod holders 20 should be positioned so that the bucket handle 14 can still be utilized, in that the handle 14 is able clear the open tops 22 to either side of the bucket 10. The rod holders 20 are preferably provided with an open bottom 23 so that water may readily drain. A rod stop member 24 is positioned near the open bottom 23 to retain the fishing rod butt. As shown, the rod stop member 24 is preferably formed by extending the rod portion of the lowermost mechanical fasteners 25 utilized to attach the rod holders 20 to the interior of the bucket side wall 12, as seen in FIG. 3. The mechanical fasteners 25 may comprise any suitable means for securing the rod holders 20 to the bucket 10, but most preferably each comprise a set of a threaded bolt, spacers or washers, and a nut, preferably a wing nut. Alternatively, the rod stop members 24 may comprise an apertured cap member, as shown in FIG. 6, in which case the rod holders 20 may be mounted to the bucket wall 12 using an annular sleeve bracket 26 or similar external securing means.

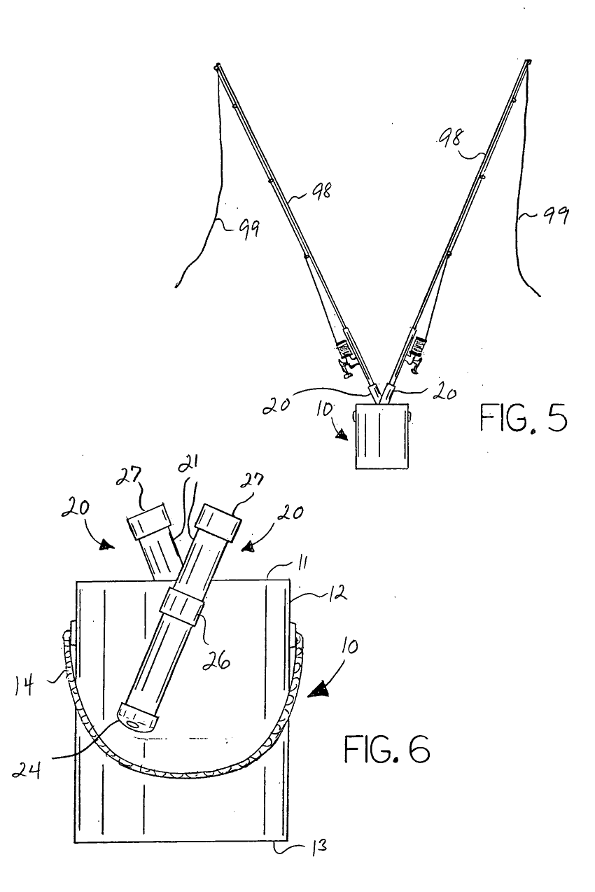

The rod holders 20 are disposed on opposite sides of bucket 10, preferably on the interior of the wall 12, at an acute angle out of vertical, and most importantly are angled such that one rod holder 20 is slanted toward one side of the bucket 10 while the other rod holder 20 is slanted toward the opposite side of the bucket 10. In other words, one rod holder 20 faces or points in a first direction and the second rod holder 20 faces or points in a second and opposite direction, most preferably approximately 180 degrees. This arrangement is critical so that the tips and the fishing lines 99 of the two fishing rods 98 retained by the rod holders 20 are separated the maximum possible distance for any given angle, as shown in FIG. 5. During use, this minimizes the likelihood of one rod tip interfering with the other rod tip or of one fishing line 99 entangling with the other.

Alternative embodiments are possible for the invention. As shown in FIG. 4, one or more slots may be provided so that the angle of the rod holders 20 may be adjusted to be more or less inclined depending on the fishing situation. The rod holders 20 may be disposed on the interior, as shown in FIGS. 1 through 3, or the exterior, as shown in FIG. 6, of the bucket 10. Other alternatives include the provision of a third or fourth rod holder 20 disposed vertically in order to increase the number of fishing rods 98 that can be retained or stored in the bucket 10. Interior or exterior compartments and retainer devices, fixed or removable, may be provided to hold tackle, knives, etc. Flotation devices can be added to allow use of the device for wade fishing.

To use the invention, the bucket 10 is preferably loaded with sufficient weight to insure that it will not easily overturn, such as with sand, rocks, water, equipment, etc. The bucket 10 is then oriented relative to the shore, pier, etc., so that the rod holders 10 extend laterally—one to the left and one to the right—of the fishing direction. Each fishing pole 98 is then cast, the drag is set to allow the line 99 to run relatively freely in the event of a strike, and the pole 98 is inserted into a rod holder 20. As previously discussed, this results in maximum separation of the rod tips. When a fish strikes, the fishing rod 98 is quickly removed from the rod holder 20 to reel in the fish. When finished, the ballast in the bucket 10 is dumped and the bucket 10 can be used to transport fish, equipment, etc.

It is understood that equivalents and substitutions for certain elements set forth above may be obvious to those skilled in the art, and thus the true scope and definition of the invention is to be as set forth in the following claims.

1. A device for holding at least two fishing rods, the device comprising:
a bucket having an upstanding wall;
a first rod holder mounted to said wall at an acute angle out of vertical;
a second rod holder mounted to said wall opposite from said first rod holder at an acute angle out of vertical and in a direction opposite to the direction in which said first rod holder is mounted.

2. The device of claim 1, wherein said first and said second rod holders are mounted at approximately 180 degrees to each other.

3. The device of claim 1, wherein said first and said second rod holders each comprise a sleeve body having an open top, an open bottom and a rod stop member.

4. The device of claim 3, wherein said first and said second rod holders are mounted to said bucket wall using mechanical fasteners.

5. The device of claim 3, wherein said rod stop members each comprise an apertured cap mounted on said open bottom of each said first and said second rod holders.

6. The device of claim 4, wherein one of said mechanical fasteners comprises said rod stop member for each said first and second rod holder.

7. The device of claim 4, wherein said bucket wall is provided with at least one curved slot through which one of said mechanical fasteners is passed, such that the acute angle for at least one of said first and said second rod holders may be altered.

8. The device of claim 1, wherein said first and said second rod holders are mounted on the interior of said bucket.

9. The device of claim 1, wherein said bucket further comprises a handle, and whereby said first and said second rod holders are mounted on said bucket such that movement of said handle is not interfered with.

10. A device for holding at least two fishing rods, the device comprising:
a container having an upstanding wall, a closed bottom and an open top defined by a rim;
a first rod holder mounted to said container at an acute angle out of vertical;
a second rod holder mounted to said container opposite from said first rod holder at an acute angle out of vertical and in a direction opposite to the direction in which said first rod holder is mounted;
wherein said first and said second rod holders extend above said container rim.

11. The device of claim 10, wherein said first and said second rod holders are mounted at approximately 180 degrees to each other.

12. The device of claim 10, wherein said first and said second rod holders each comprise a sleeve body having an open top, an open bottom and a rod stop member.

13. The device of claim 12, wherein said first and said second rod holders are mounted to said container using mechanical fasteners.

14. The device of claim 12, wherein said rod stop members each comprise an apertured cap mounted on said open bottom of each said first and said second rod holders.

15. The device of claim 13, wherein one of said mechanical fasteners comprises said rod stop member for each said first and second rod holder.

16. The device of claim 13, wherein said container is provided with at least one curved slot through which one of said mechanical fasteners is passed, such that the acute angle for at least one of said first and said second rod holders may be altered.

17. The device of claim 10, wherein said first and said second rod holders are mounted on the interior of said container.

18. The device of claim 10, wherein said container further comprises a handle, and whereby said first and said second rod holders are mounted on said container such that movement of said handle is not interfered with.

19. A fishing rod holder device comprising:
a bucket having a wall, a handle, an open top and a closed bottom;
a first rod holder mounted to said wall at an acute angle out of vertical and pointing in a first direction;
a second rod holder mounted to said wall opposite from said first rod holder at an acute angle out of vertical and pointing in a second direction opposite to said first direction;
each of said first and said second rod holders comprising a sleeve body, an open top and a rod stop member, wherein said rod holder open tops extend above said bucket open top and wherein said first and said second rod holders do not interfere with movement of said handle; and
wherein said first and said second rod holders are mounted to said bucket wall using mechanical fasteners.

20. The device of claim 19, wherein said first and said second rod holders are mounted to the interior of said bucket.
